(19) United States
(12) Patent Application Publication
(10) Pub. No.: US 2023/0331096 A1
(43) Pub. Date: Oct. 19, 2023

(54) APPARATUS AND METHOD FOR CONTROLLING OF MOTION OF VEHICLE

(71) Applicants: Hyundai Motor Company, Seoul (KR); Kia Corporation, Seoul (KR)

(72) Inventor: Sheen Gil Kang, Yongin (KR)

(21) Appl. No.: 17/978,073

(22) Filed: Oct. 31, 2022

(30) Foreign Application Priority Data
Apr. 13, 2022 (KR) 10-2022-0045848

(51) Int. Cl. B60L 15/20

(52) U.S. Cl. CPC B60L 15/20; B60L 2240/423; B60L 2260/22; B60L 2240/80

(57) ABSTRACT

Disclosed are an apparatus and a method for controlling a motion of a vehicle. An apparatus for controlling a motion of a vehicle includes a driving motor operated based on a basic torque calculated to control a speed of the vehicle according to a target speed. The apparatus may further include a controller that is configured to control a torque of the driving motor by determining a stop state of the vehicle calculating a pitch rate of the vehicle from a driving state to the stop state calculating a control level based on the pitch rate, and compensating the basic torque with the control level.

### CROSS-REFERENCE TO RELATED APPLICATION

This application claims under 35 U.S.C. § 119(a) the benefit of and priority to Korean Patent Application No. 10-2022-0045848, filed in the Korean Intellectual Property Office on Apr. 13, 2022, the entire contents of which are incorporated herein by reference.

### FIELD

The present disclosure relates to an apparatus and a method for controlling a motion of a vehicle, and more particularly, to a technology for alleviating degradation of a riding feeling due to a pitch.

### BACKGROUND

Studies on environment-friendly motor-driven vehicles, such as electric vehicles or hydrogen electric vehicles, have been actively made in replacement of existing combustion engine type vehicles. The motor-driving vehicles employ a driving motor that is operated based on electricity in replacement of an engine. The driving motor has a high control response, and a torque of the motor may be precisely predicted, and wheels may be independently driven by mounting electric motors on the wheels.

Technologies for controlling a motion of a vehicle, which influences a riding feeling of a vehicle by utilizing advantages of the electric motor have been suggested. Among them, a technique for controlling a pitch motion of a vehicle is directed to restraining pitch motions that may be unnecessarily generated while the vehicle is traveling and gives an uncomfortable feeling to a driver.

A conventional technology for reducing a pitch motion is mainly based on a kinematic design of a suspension. Because a change of a design of the suspension is closely related to other configurations and other performances, there is a limit in changing a design for reducing a pitch.

### SUMMARY

The present disclosure has been made to solve the above-mentioned problems occurring in the prior art while advantages achieved by the prior art are maintained intact.

An aspect of the present disclosure provides an apparatus and a method for controlling a motion of a vehicle, by which a suspension may be freely designed.

Another aspect of the present disclosure provides an apparatus and a method for controlling a motion of a vehicle, by which degradation of a riding feeling due to a pitch in case of rapid braking of a vehicle may be efficiently alleviated.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for controlling a motion of a vehicle includes a driving motor that is operated according to a basic torque that is calculated to control a speed of the vehicle to a target speed, and a controller configured to: continuously determine d a stop state of the vehicle, continuously calculate a pitch rate of the vehicle from a driving state to the stop state, continuously calculate a control level based on the pitch rate, and continuously control and update a torque applied to the driving motor by compensating the basic torque with the control level.

In an embodiment of the present disclosure, the controller may be further configured to continuously calculate a suspension longitudinal deformation degree measured from the driving state to the stop state, continuously calculate and update the control level according to a first equation, (k−1)-th, to determine a most recently calculated control level, wherein k is a natural number of two or more, and continuously calculate and update the pitch rate based on the suspension longitudinal deformation degree and the most recently calculated control level.

In an embodiment of the present disclosure, the controller may be further configured to set an initial control level value to 0.

In an embodiment of the present disclosure, the controller may be configured to calculate the suspension longitudinal deformation degree based on a displacement of a pitch center at a corresponding to a point at which there is no relative motion between a vehicle body and a suspension of the vehicle.

In an embodiment of the present disclosure, the controller may be further configured to detect a stop timing at a corresponding point in time, and calculate the suspension longitudinal deformation degree based on a corresponding pitch and a corresponding longitudinal force detected at the corresponding point in time.

In an embodiment of the present disclosure, the controller may be further configured to detect the stop timing based on a corresponding point in time at which a speed of the vehicle is less than or equal to a threshold value and a brake of the vehicle is operated.

In an embodiment of the present disclosure, the controller may be further configured to calculate the suspension longitudinal deformation degree at the corresponding stop timing based on a condition in which a restoring force due to displacement of the suspension of the vehicle is in equilibrium with a longitudinal force.

In an embodiment of the present disclosure, the controller may be further configured to calculate the corresponding pitch and a longitudinal force based on a braking torque of a brake in a driving state, the corresponding pitch and the longitudinal force being used to calculate the suspension longitudinal deformation degree at the stop timing.

In an embodiment of the present disclosure, the controller may be further configured to calculate the k-th pitch rate based on a pitch motion equation in the stop state.

In an embodiment of the present disclosure, the controller may be further configured to calculate the control level such that the control level is proportional to the pitch rate.

According to an aspect of the present disclosure, a method for controlling a motion of a vehicle includes determining, continuously, a stop state of the vehicle, calculating and updating, continuously, a pitch rate of the vehicle from a driving state to the stop state, calculating, continuously, a control level based on the pitch rate, and controlling and updating, continuously, a torque of a driving motor based on the control level.

In an embodiment of the present disclosure, wherein calculating and updating the pitch rate step may further include calculating a suspension longitudinal deformation degree from the driving state to the stop state, calculating an updated control level according to a first equation (k−1)-th, to determine a most recently calculated control level, and calculating an updated pitch rate based on the suspension longitudinal deformation degree and the most recently calculated control level.

In an embodiment of the present disclosure, further comprising setting an initial control level to 0.

In an embodiment of the present disclosure, the calculating of the suspension longitudinal deformation degree step may further include calculating a displacement of a pitch center corresponding to a point in time at which there is no relative motion between a vehicle body and a suspension of the vehicle.

In an embodiment of the present disclosure, the calculating of the suspension longitudinal deformation degree step may further include detecting a stop timing at a corresponding point in time, and calculating the suspension longitudinal deformation degree based on a corresponding pitch and a corresponding longitudinal force detected at the corresponding stop timing.

In an embodiment of the present disclosure, the detecting of the stop timing step may further include detecting a timing, at which the speed of the vehicle is equal to or less than a threshold value and a brake of the vehicle is operated.

In an embodiment of the present disclosure, the calculating of the suspension longitudinal deformation degree based on the corresponding pitch and a corresponding longitudinal force at the corresponding stop timing may include using a condition, in which a restoring force due to displacement of the suspension of the vehicle is in equilibrium with the longitudinal force

In an embodiment of the present disclosure, the calculating of the suspension longitudinal deformation degree based on the corresponding pitch and the corresponding longitudinal force at the corresponding stop timing may further include calculating the corresponding pitch and the corresponding longitudinal force based on a braking torque of a brake in the driving state.

In an embodiment of the present disclosure, wherein calculating and updating of the pitch rate step further includes using a pitch motion equation in the stop state.

In an embodiment of the present disclosure, the calculating and updating of the control level step may further include calculating the control level such that the control level is proportional to the pitch rate.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a vehicle according to an embodiment of the present disclosure;

FIG. 2 is a view illustrating a configuration of an apparatus for controlling a motion of a vehicle according to an embodiment of the present disclosure;

FIG. 3 is a flowchart illustrating a method for controlling a motion of a vehicle according to an embodiment of the present disclosure;

FIG. 4 is a view illustrating a specification of a vehicle;

FIG. 5 is a flowchart illustrating a method for controlling a motion of a vehicle according to an embodiment of the present disclosure;

FIG. 6 is a view depicting an operation of a controller of calculating a pitch and a longitudinal force;

FIG. 7 is a view depicting an operation of a controller of calculating suspension longitudinal deformation degrees;

FIG. 8 is a schematic diagram illustrating an operation of a controller of calculating a braking torque of a brake and a longitudinal acceleration;

FIG. 9 is a schematic diagram illustrating an operation of a controller of calculating a pitch and a pitch rate;

FIG. 10 is a schematic diagram illustrating an operation of a controller of calculating a control level; and

FIG. 11 is a view illustrating a computing system according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

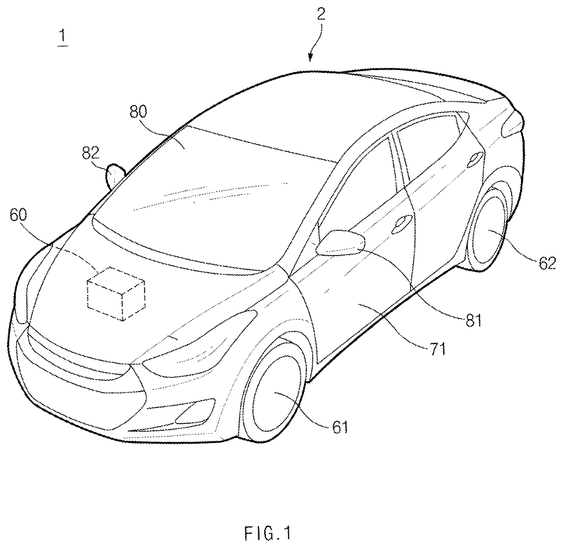

Hereinafter, embodiments of the present disclosure will be described in detail with reference to FIGS. 1 to 11.

FIG. 1 is a view illustrating a vehicle according to an embodiment of the present disclosure.

Referring to FIG. 1, a vehicle 1 according to an embodiment of the present disclosure may include a body 2 that defines an external appearance thereof, wheels 61 and 62 that move the vehicle 1, a driving device 60 that rotates the wheels 61 and 62, a door 71 that shields an interior of the vehicle 1 from an outside, a front glass 80 that provides a front field of view of the vehicle 1 to a user in the interior of the vehicle 1, and side mirrors 81 and 82 that provide side and rear fields of view of the vehicle 1 to the user.

The wheels 61 and 62 include the front wheels 61 provided on a front side of the vehicle 1 and the rear wheels 62 provided on a rear side of the vehicle 1, and the driving device 60 may provide a rotational force to the front wheels 61 or the rear wheels 62 such that the body 2 moves forwards or rearwards.

The doors 71 are provided on the left and right sides of the body 2 to be rotatable, and allow the driver to be seated in the interior of the vehicle 1 when being opened, and may shield the interior of the vehicle 1 from the outside when being closed.

The front glass 80 that is a kind of a windshield screen may be provided on a front upper side of the body 2 to provide information on the field of view of the front side of the vehicle 1 to a driver or a user in the interior of the vehicle 1.

The side mirrors 81 and 82 may include the left side mirror 81 provided on a left side of the body 2 and the right side mirror 82 provided on a right side thereof, and may provide information of fields of view of the lateral and rear sides of the vehicle 1 to the driver in the interior of the vehicle 1.

The vehicle 1 according to the embodiment of the present disclosure may be a motor-based vehicle. For example, the vehicle 1 according to an embodiment of the present disclosure may be an electric vehicle (EV), a hybrid electric vehicle (HEV), a plug-in hybrid electric vehicle (PHEV), or a fuel cell electric vehicle (FCEV). Accordingly, in an embodiment of the present disclosure, the driving device 60 may be a driving motor that is rotated by using electric energy.

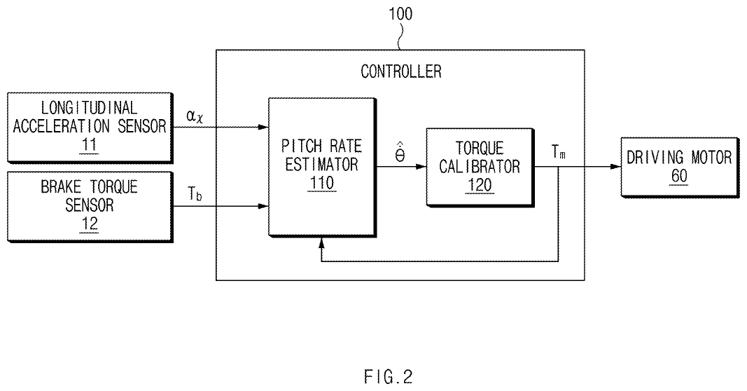

FIG. 2 is a view illustrating a configuration of an apparatus for controlling a motion of a vehicle according to an embodiment of the present disclosure.

Referring to FIG. 2, the apparatus for controlling a motion according to an embodiment of the present disclosure may include a longitudinal acceleration sensor 11, a brake torque sensor 12, a controller 100, and a driving motor 60.

The longitudinal acceleration sensor 11 may measure a longitudinal acceleration of the vehicle. The longitudinal acceleration sensor 11 may be implemented by a 3-axis acceleration gauge.

The brake torque sensor 12 may acquire information of a torque of a brake. The brake torque sensor 12 according to an embodiment may estimate a frictional coefficient based on a rotational speed of a brake disk, a temperature of the brake disk, and a hydraulic pressure of the brake. The brake torque sensor 12 may acquire the torque of the brake based on the frictional coefficient.

The controller 100 may determine a stop state of the vehicle, and may calculate a pitch rate of the vehicle from a driving state to the stop state. The pitch rate may refer to a change rate of a pitch.

The controller 100 may calculate a control level based on the pitch rate. The controller 100 may control a torque of the driving motor by compensating a basic torque with the control level. According to an embodiment, the controller 100 may drive the driving motor 60 based on a torque obtained by adding the control level to the basic torque.

The driving motor 60 may be operated based on the basic torque calculated to control a speed of the vehicle to a target speed.

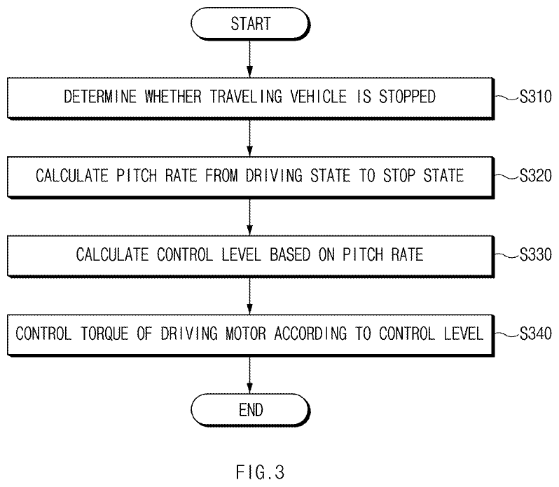

FIG. 3 is a flowchart illustrating a method for controlling a motion of a vehicle according to an embodiment of the present disclosure. Hereinafter, the method for controlling a motion of a vehicle according to an embodiment of the present disclosure may be performed by a processor illustrated in FIG. 2.

Referring to FIG. 3, the method for controlling a motion of a vehicle according to an embodiment of the present disclosure will be described as follows.

In S310, a pitch rate estimator 110 of the controller 100 may determine whether the vehicle that is traveling is stopped.

The pitch rate estimator 110 may determine whether the vehicle is stopped by detecting whether the speed of the vehicle is a threshold speed or less and a timing, at which the brake is operated. The timing, at which the brake is operated, may be identified based on that a brake pedal signal is an on signal or the torque of the brake is more than the threshold torque.

In more detail, the pitch rate estimator 110 may identify a first condition and a second condition to determine whether the vehicle is stopped.

The pitch rate estimator 110 may identify the speed of the vehicle in the first condition. The pitch rate estimator 110 may generate a first level signal based on that the speed of the vehicle is less than the threshold speed, or may generate a second level signal based on that the speed of the vehicle is more than the threshold speed.

The pitch rate estimator 110 may identify the operation of the brake in the second condition. The pitch rate estimator 110 may generate the first level signal based on that the brake pedal signal is an on signal or the torque of the brake is more than the threshold torque, or may generate the second level signal based on that the brake pedal signal is an off signal or the torque of the brake is less than the threshold torque.

The pitch rate estimator 110 may determine that the vehicle is in the stop state when the signals of the first level are generated in both of the first condition and the second condition. In particular, the pitch rate estimator 110 may determine a moment, at which the first level signals are output in both of the first condition and the second condition in a state, in which the second level signal is output in any one of the first condition and the second condition, as a timing, at which the vehicle is stopped.

In S320, the pitch rate estimator 110 of the controller 100 may calculate the pitch rate from the driving state to the stop state.

The pitch rate estimator 110 may calculate the suspension longitudinal deformation degree from the driving state to the stop state to calculate a k-th pitch rate (k is a natural number of two or more). Furthermore, the pitch rate estimator 110 may calculate a (k−1)-th control level. The pitch rate estimator 110 may calculate the k-th pitch rate based on a change rate of a location of the suspension and the (k−1)-th control level.

The pitch rate estimator 110 may calculate the pitch rate based on that an initial control level is set to 0 (zero).

The suspension longitudinal deformation degree may be estimated according to a change rate of a reference point that is preset in the vehicle body or the suspension. According to an embodiment, the pitch rate estimator 110 may calculate the suspension longitudinal deformation degree in a state, in which a pitch center corresponding to a point, at which there is no relative motion between the vehicle body and the suspension.

The suspension longitudinal deformation degree may be calculated based on that the timing, at which the vehicle is stopped, is detected. The pitch rate estimator 110 may calculate the suspension longitudinal deformation degree based on the pitch and the longitudinal force.

The pitch and the braking torque of the brake may be calculated while the vehicle is traveling. The pitch rate estimator 110 may calculate the pitch and the longitudinal force based on the braking torque of the brake. To achieve this, the pitch rate estimator 110 may calculate the pitch and the longitudinal force by using a pitch motion equation.

In S330, a torque calibrator 120 may calculate the control level based on the pitch rate.

The torque calibrator 120 may calculate the control level such that the control level is proportional to the pitch rate.

In S340, the torque calibrator 120 of the controller 100 may calibrate a torque of the driving motor 60 based on the control level.

To control the torque of the driving motor, the controller 100 may compensate for a basic torque value by adding the control level to the basic torque value. The basic torque value is calculated by excluding elements due to a pitch motion of the vehicle, and may be calculated based on a pressure applied to an accelerator pedal or an angle of the accelerator pedal.

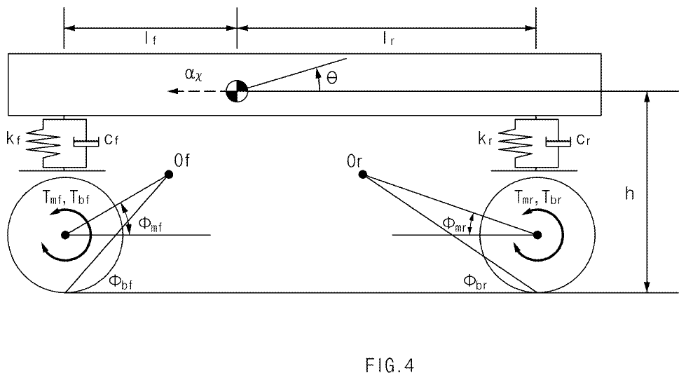

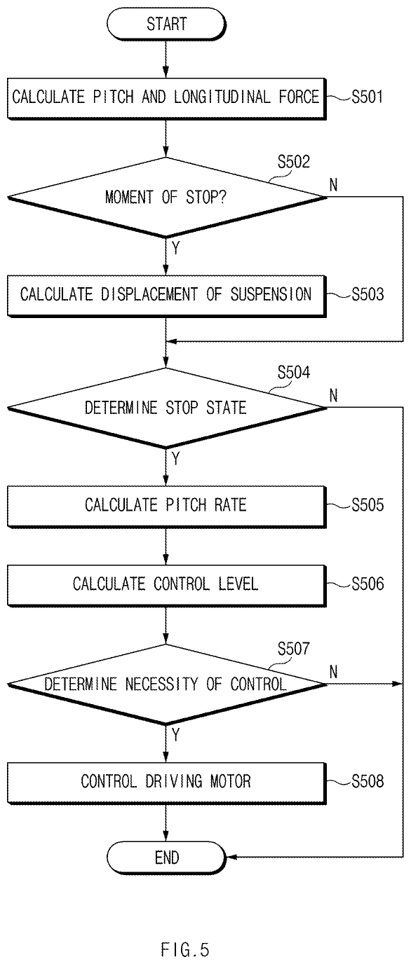

FIG. 4 is a view illustrating a specification of a vehicle. FIG. 5 is a flowchart illustrating a method for controlling a motion of a vehicle according to another embodiment of the present disclosure.

Referring to FIGS. 4 and 5, the method for controlling a motion of a vehicle according to another embodiment of the present disclosure will be described as follows.

In S501, the controller 100 may calculate the pitch (θ) and the longitudinal force (Fₓ) in the driving state of the vehicle.

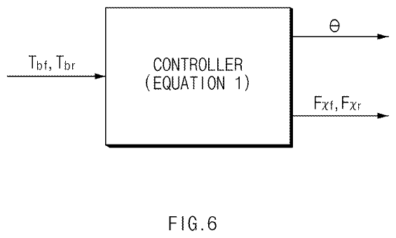

FIG. 6 is a view depicting an operation of the controller of calculating the pitch and the longitudinal force.

Referring to FIG. 6, the controller 100 may calculate the pitch (θ) in the driving state, based on Equation 1 as follows.

$$I \ddot{θ} + ( {c}_{f} {l}_{f}^{2} + {c}_{r} {l}_{r}^{2} ) \dot{θ} + ( {k}_{f} {l}_{f}^{2} + {k}_{r} {l}_{r}^{2} ) θ = - m {a}_{x} h + \frac{{T}_{b f}}{r} tan {ϕ}_{b f} {l}_{f} + \frac{{T}_{b r}}{r} tan {ϕ}_{br} {l}_{r}$$

In Equation 1, l may mean a rotational inertial moment in a direction of the pitch. θ may mean a pitch. θ may mean a change rate of the pitch, that is, an angular velocity of the pitch, and \ddot{θ} may mean a change rate of a pitch rate, that is, an angular acceleration of the pitch. c_{f} may mean a damping coefficient of a front wheel suspension, and cᵣ may mean a damping coefficient of a rear wheel suspension. l_{f} may mean a distance from a center of the vehicle to a front wheel axle, and lᵣ may mean a distance from a center of the vehicle to a rear wheel axle. k_{f} may mean a stiffness of the front wheel suspension, and kᵣ may mean a stiffness of the rear wheel suspension. m may mean a mass of the vehicle. aₓ may mean a longitudinal acceleration. h may mean a height from a ground surface to a center of weight of the vehicle. T_{bf} may mean a torque of a front wheel brake, and T_{br} may mean a torque of a rear wheel brake. ϕ_{bf} may mean an angle between a line that connects a point, at which a tire and the ground surface contact each other, and a pitch center of the front wheels, and the ground surface, and ϕ_{br} may mean an angle between a line that connects a point, at which a tire and the ground surface contact each other, and a pitch center of the rear wheels, and the ground surface. ϕ_{mf} may mean an angle between a line that connects a point, at which a center of the tire and a pitch center of the front wheels, and the ground surface and ϕₘᵣ may mean an angle between a line that connects a point, at which a center of the tire and a pitch center of the rear wheels, and the ground surface.

Furthermore, the controller 100 may calculate the longitudinal force based on the torque of the brake. The controller 100 may calculate a front wheel longitudinal force (F_{xf}) based on the torque (T_{bf}) of the front wheel brake, and may calculate a rear wheel longitudinal force (Fₓᵣ) based on the torque (T_{br}) of the rear wheel brake. The controller 100 may use a condition equation of

$${F}_{x f} = \frac{{T}_{bf}}{r} , {F}_{xr} . = \frac{{T}_{br}}{r}$$

to calculate the longitudinal force. Then, r may mean a radius of the tire.

In S502, it may be determined whether the vehicle is at the moment of stop. The procedure S502 may be a procedure of determining a timing, at which the vehicle that is traveling is stopped.

The pitch rate estimator 110 may identify the first condition and the second condition to determine the stop timing of the vehicle.

The pitch rate estimator 110 may identify the speed of the vehicle in the first condition. The pitch rate estimator 110 may generate a first level signal based on that the speed of the vehicle is less than the threshold speed, and may generate a second level signal based on that the speed of the vehicle is more than the threshold speed.

The pitch rate estimator 110 may identify the operation of the brake in the second condition. The pitch rate estimator 110 may generate the first level signal based on that the brake pedal signal is an on signal or the torque of the brake is more than the threshold torque, or may generate the second level signal based on that the brake pedal signal is an off signal or the torque of the brake is less than the threshold torque.

The pitch rate estimator 110 may determine that the vehicle is traveling in a state, in which the second level signal is output in any one of the first condition and the second condition. Further, the pitch rate estimator 110 may determine a moment, at which the first level signals are output in both of the first condition and the second condition, as a timing, at which the vehicle is stopped.

In S503, the controller 100 may calculate the suspension longitudinal deformation degrees (x_{0f}, x₀ᵣ) at the timing, at which the vehicle is stopped.

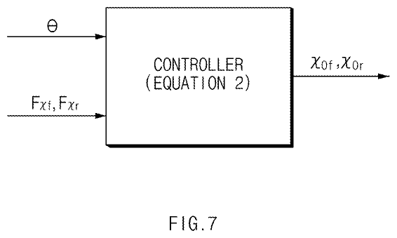

FIG. 7 is a view depicting an operation of the controller of calculating change rates of a location of the suspension.

The suspension longitudinal deformation degrees (x_{0f},x₀ᵣ) may be change of pitch centers (Of, Or) illustrated in FIG. 4, respectively. The front wheel suspension longitudinal deformation degree (x_{0f}) may be a change in a longitudinal location of the pitch center (Of) of the front wheels, and the rear wheel suspension longitudinal deformation degree (x₀ᵣ) may be a change in a longitudinal location of the pitch center (Or) of the rear wheels.

A restoring force due to displacement of the pitch center (Of) of the front wheels at the stop moment of the vehicle may be in equilibrium with the longitudinal force of the front wheels, and a restoring force due to displacement of the pitch center (Or) of the rear wheels may be in equilibrium with the longitudinal force of the rear wheels. That is, at the stop moment of the vehicle, a condition of “F_{xf}=−K_{cf}(x_{0f}+x−η_{f}z_{f})−C_{cf} (\dot{x}−η_{f}ż_{f})” and a condition of “Fₓᵣ=−K_{cr}(x₀ᵣ+x+ηᵣzᵣ)−C_{cr}(\dot{x}+ηᵣżᵣ)” have to be satisfied. Accordingly, the controller 100 may calculate a front wheel suspension longitudinal deformation degree and a rear wheel suspension longitudinal deformation degree based on Equation 2 as follows.

x_{0f}=η_{f}z_{f}−F_{xf}/K_{cf} Equation 2

x₀ᵣ=−ηᵣzᵣ−Fₓᵣ/K_{cr}

Then, x₀ᵣ=−ηᵣzᵣ−Fₓᵣ/K_{cr} means a front wheel suspension stroke, and may be obtained by using a relationship equation expressed by z_{f}=−l_{f}θ. Furthermore, zᵣ means a rear wheel suspension stroke, and may be obtained by using a relationship equation expressed by zᵣ=lᵣθ.

Furthermore, η_{f} is a constant that represents a longitudinal displacement of a ground surface contact point of the front wheel per unit stroke of the front wheel suspension, and may satisfy a condition of η_{f}=∂x_{f}/∂z_{f}.

Furthermore, ηᵣ is a constant that represents a longitudinal displacement of a ground surface contact point of the rear wheel per unit stroke of the rear wheel suspension, and may satisfy a condition of ηᵣ=∂xᵣ/∂zᵣ.

K_{cf} may be a constant that represents a total stiffness for the pitch center of the front wheels, that is, a longitudinal direction of a fastening part of the front wheel suspension. K_{cr} may be a constant that represents a total stiffness for a longitudinal direction of a fastening part of the rear wheel suspension.

In S504, it may be determined whether the vehicle is in a stop state.

The pitch rate estimator 110 may determine whether the vehicle is in a stop state in unit of a specific time period. That is, the procedures after S504 may be repeated in unit of a specific time period. In S502, a moment, at which the traveling vehicle is stopped, may be detected, and in S504, it may be determined whether the vehicle is maintained in the stop state.

The pitch rate estimator 110 may identify the first condition and the second condition, which are utilized in operation S502, to determine whether the vehicle is stopped.

The pitch rate estimator 110 may determine that the vehicle is in the stop state when the signals of the first level are maintained in both of the first condition and the second condition.

In S505, the controller 110 may calculate a pitch (\hat{θ}) and a pitch rate (\hat{\dot{θ}}). The pitch (\hat{θ}) may mean a pitch calculated by the controller, and the pitch rate (\hat{\dot{θ}}) may mean a change rate of the calculated pitch.

The controller 100 may calculate the pitch (\hat{θ}) and the pitch rate (\hat{\dot{θ}}), based on the braking torque (T_{bf}) of the front wheel brake, the braking torque (T_{br}) of the rear wheel brake, the longitudinal acceleration (aₓ), the torque (T_{mf}) of the front wheel driving motor, and the torque (Tₘᵣ)) of the rear wheel driving motor.

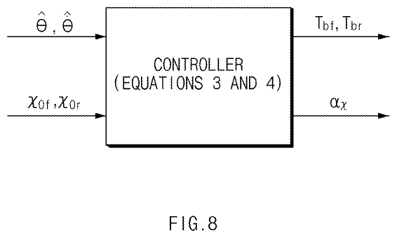

FIG. 8 is a schematic diagram illustrating an operation of the controller of calculating the braking torque of a brake and the longitudinal acceleration.

The braking torque (T_{bf}) of the front wheel brake and the torque (T_{br}) of the rear wheel brake may be acquired by the brake torque sensor 12 or be calculated through Equation 3 as follows. Equation 3 may be established because the braking torque is higher than the driving torque when a braking pressure is sufficient.

T_{bf}=rF_{xf}−T_{mf},T_{br}=rFₓᵣ−Tₘᵣ Equation 3

Furthermore, the longitudinal acceleration (aₓ) may be acquired by the longitudinal acceleration sensor 11 or be calculated based on Equation 4 as follows.

$${a}_{x} = \ddot{x} = \frac{1}{m} ( {F}_{x f} + {F}_{xr} ) \qquad [ Equation 4 ]$$

Then, F_{xf} may mean a force applied to the vehicle body by the front wheel suspension in the x axis direction, and Fₓᵣ may mean a force applied to the vehicle body by the rear wheel suspension in the x axis direction.

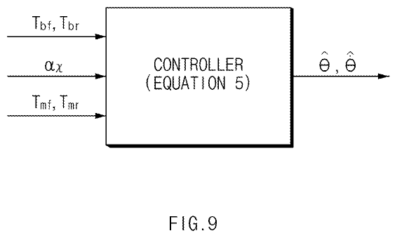

FIG. 9 is a schematic diagram illustrating an operation of the controller of calculating a pitch and a pitch rate.

Referring to FIG. 9, the controller 100 may calculate the pitch (\hat{θ}) and the pitch rate (\hat{\dot{θ}}), based on the braking torque (T_{bf}) of the front wheel brake, the braking torque (T_{br}) of the rear wheel brake, the longitudinal acceleration (aₓ), the torque (T_{mf}) of the front wheel driving motor, and the torque (Tₘᵣ) of the rear wheel driving motor.

The pitch (\hat{θ}) and the pitch rate (\hat{\dot{θ}}) may be calculated through a vehicle pitch motion equation expressed in Equation 5 as follows. The vehicle pitch motion equation expressed in Equation 1 may be applied even when the vehicle is traveling, whereas the vehicle pitch motion equation expressed in Equation 3 may be applied even when the vehicle is in the stop state.

$$I \ddot{θ} + ( {c}_{f} {l}_{f}^{2} + {c}_{r} {l}_{r}^{2} ) \dot{θ} + ( {k}_{f} {l}_{f}^{2} + {k}_{r} {l}_{r}^{2} ) θ = - m {a}_{x} h + ( \frac{{T}_{mf}}{r} tan {ϕ}_{mf} + \frac{{T}_{bf}}{r} tan {ϕ}_{bf} ) {l}_{f} + ( \frac{{T}_{mr}}{r} tan {ϕ}_{mr} + \frac{{T}_{br}}{r} tan {ϕ}_{br} ) {l}_{r} \qquad [ Equation 5 ]$$

The torque (T_{mf}) of the front wheel driving motor, the torque (Tₘᵣ) of the rear wheel driving motor, and the longitudinal acceleration (aₓ) in Equation 5 may satisfy the relationship equation as in Equation 6 as follows.

$$\frac{{T}_{mf} + {T}_{b f}}{r} + \frac{{T}_{m r} + {T}_{b r}}{r} = m {a}_{x} \qquad [ Equation 6 ]$$

Furthermore, an initial torque (T_{mf}) of the front wheel driving motor and an initial torque (Tₘᵣ) of the rear wheel driving motor may be set to 0. Furthermore, the torque (T_{mf}^{(k-1)}) of the front wheel driving motor and the torque (Tₘᵣ^{(k-}1)) of the rear wheel driving motor in a process of calculating the k-th pitch rate (\hat{\dot{θ}}) may be calculated in Equation 5, based on the (k−1)-th torque (T_{mf}) of the front wheel driving motor and the initial torque (Tₘᵣ) of the rear driving motor.

In S506, the controller 100 may calculate the control level.

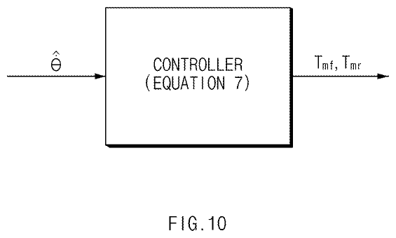

FIG. 10 is a schematic diagram illustrating an operation of the controller of calculating a control level.

The control level may mean a calibration value for controlling the torque of the driving motor, and may be the torque (T_{mf}) of the front wheel driving motor and the initial torque (Tₘᵣ) of the rear wheel driving motor, which have been described above.

The braking or driving moment of the driving motor 60 may be proportional to the pitch rate (\hat{\dot{θ}}). The pitch rate (\hat{\dot{θ}}) may mean the pitch rate calculated based on Equation 3.

The controller 100 may calculate the control level (T_{mf}) of the torque of the front wheel driving motor and the control level (Tₘᵣ) of the torque of the rear wheel driving motor through Equation 7 as follows.

T_{mf}=−K_{pf}\hat{\dot{θ}} Equation 7

Tₘᵣ=−Kₚᵣ\hat{\dot{θ}}

In S507, the controller 100 may determine whether it is necessary to control the torque of the driving motor 60.

According to an embodiment, the controller 100 may determine that it is necessary to control the torque of the driving motor 60 based on that the speed of the vehicle 1 is a threshold speed or less.

According to an embodiment, the controller 100 may determine that it is necessary to control the torque of the driving motor 60 based on that the brake is operated. The controller 100 may determine that the brake is operated, when the braking pedal signal is of an on level or the torque of the brake is higher than 0.

In 3508, the controller 100 may control the torque of the driving motor 60 based on the control level (Tmnf) of the torque of the front wheel driving motor and the control level (Tₘᵣ) of the torque of the rear wheel driving motor, which have been calculated in S507.

To control the torque of the driving motor, the controller 100 may compensate for a basic torque value by adding the control level to the basic torque value. The basic torque value is calculated by excluding elements due to a pitch motion of the vehicle, and may be calculated based on a pressure applied to an accelerator pedal or an angle of the accelerator pedal.

That is, the controller 100 may control the torque of the front wheel driving motor by adding the control level (T_{mf}) of the torque of the front wheel driving motor to the basic torque value, and may control the torque of the rear wheel driving motor by adding the control level (Tₘᵣ) of the torque of the rear wheel driving motor to the basic torque value.

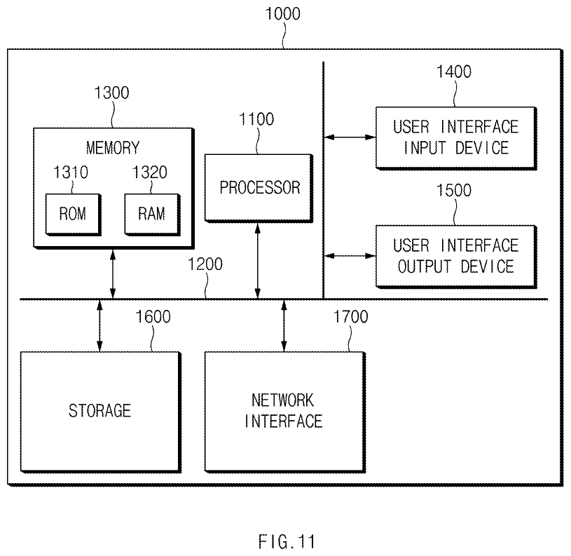

FIG. 11 is a view illustrating a computing system according to an embodiment of the present disclosure.

Referring to FIG. 11, a computing system 1000 may include at least one processor 1100, a memory 1300, a user interface input device 1400, a user interface output device 1500, storage 1600, and a network interface 1700 which are connected through a bus 1200.

The processor 1100 may be a central processing unit (CPU) or a semiconductor device that processes instructions stored in the memory 1300 and/or the storage 1600. In particular, the processor 1100 according to an embodiment of the present disclosure may include configurations of the controller 100 illustrated in FIG. 2. The memory 1300 and the storage 1600 may include various volatile or nonvolatile storage media. For example, the memory 1300 may include a read only memory (ROM) and a random access memory (RAM).

Accordingly, the steps of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM memory, a flash memory, a ROM memory, an EPROM memory, an EEPROM memory, a register, a hard disk, a detachable disk, or a CD-ROM.

The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

According to an embodiment of the present disclosure, a degree of freedom of a design of a suspension may be increased by controlling a driving torque without changing the design of the suspension to reduce a pitch motion.

Furthermore, according to an embodiment of the present disclosure, because a torque of a driving motor is controlled according to a moment, at which a vehicle is stopped, and a stop state of the vehicle, a pitch motion at an abrupt stop moment may be efficiently improved.

In addition, the present disclosure may provide various effects that are directly or indirectly recognized.

The above description is a simple exemplification of the technical spirits of the present disclosure, and the present disclosure may be variously corrected and modified by those skilled in the art to which the present disclosure pertains without departing from the essential features of the present disclosure.

Accordingly, the embodiments disclosed in the present disclosure is not provided to limit the technical spirits of the present disclosure but provided to describe the present disclosure, and the scope of the technical spirits of the present disclosure is not limited by the embodiments. Accordingly, the technical scope of the present disclosure should be construed by the attached claims, and all the technical spirits within the equivalent ranges fall within the scope of the present disclosure.

What is claimed is:

1. An apparatus for controlling motion of a vehicle, the apparatus comprising:
a driving motor that is operated according to a basic torque that is calculated to control a speed of the vehicle according to a target speed; and
a controller configured to:
determine a stop state of the vehicle,
calculate a pitch rate of the vehicle from a driving state to the stop state,
calculate a control level based on the pitch rate, and
control and update a torque applied to the driving motor by updating the basic torque with the control level.

2. The apparatus of claim 1, wherein the controller is further configured to:
continuously calculate a suspension longitudinal deformation degree measured from the driving state to the stop state;
continuously calculate and update the control level, according to a first equation (k−1)-th, to determine a most recently calculated control level, wherein k is a natural number of two or more; and
continuously calculate and update the pitch rate based on the suspension longitudinal deformation degree and the most recently calculated control level.

3. The apparatus of claim 2, wherein the controller is further configured to:
set an initial control level value to 0.

4. The apparatus of claim 2, wherein the controller is further configured to:
calculate the suspension longitudinal deformation degree based on a displacement of a pitch center at a corresponding point in time at which there is no relative motion between a vehicle body and a suspension of the vehicle.

5. The apparatus of claim 2, wherein the controller is further configured to:
detect a stop timing at a corresponding point in time, and
calculate the suspension longitudinal deformation degree based on a corresponding pitch and a corresponding longitudinal force detected at the corresponding stop timing.

6. The apparatus of claim 5, wherein the controller is further configured to:
detect the corresponding stop timing based on a corresponding point in time at which a speed of the vehicle is less than or equal to a threshold value and a brake of the vehicle is operated.

7. The apparatus of claim 5, wherein the controller is further configured to:
calculate the suspension longitudinal deformation degree at the corresponding stop timing based on a condition in which a restoring force due to displacement of a suspension of the vehicle is in equilibrium with a longitudinal force.

8. The apparatus of claim 5, wherein the controller is further configured to:
calculate the corresponding pitch and a longitudinal force based on a braking torque of a brake in a driving state, the corresponding pitch and the longitudinal force being used to calculate the suspension longitudinal deformation degree at the stop timing.

9. The apparatus of claim 2, wherein the controller is further configured to:
calculate the k-th pitch rate based on a pitch motion equation in the stop state.

10. The apparatus of claim 1, wherein the controller is further configured to:
calculate the control level such that the control level is proportional to the pitch rate.

11. A method for controlling a motion of a vehicle, the method comprising:
determining a stop state of the vehicle;
calculating and updating a pitch rate of the vehicle from a driving state to the stop state;
calculating a control level based on the pitch rate; and
controlling and updating a torque of a driving motor based on the control level.

12. The method of claim 11, wherein calculating and updating the pitch rate step further includes:
calculating a suspension longitudinal deformation degree from the driving state to the stop state;
calculating an updated control level according to a first equation (k−1)-th, to determine a most recently calculated control level; and
calculating an updated pitch rate based on the suspension longitudinal deformation degree and the most recently calculated control level.

13. The method of claim 12, further comprising:
setting an initial control level to 0.

14. The method of claim 12, wherein the calculating of the suspension longitudinal deformation degree includes:
calculating a displacement of a pitch center at a corresponding point in time at which there is no relative motion between a vehicle body and a suspension.

15. The method of claim 12, wherein the calculating of the suspension longitudinal deformation degree step further includes:
detecting a stop timing at a corresponding point in time; and
calculating the suspension longitudinal deformation degree based on a corresponding pitch and a corresponding longitudinal force detected at the corresponding stop timing.

16. The method of claim 15, wherein the detecting of the stop timing step further includes:
detecting a point in time at which a speed of the vehicle is equal to or less than a threshold value and a brake of the vehicle is operated.

17. The method of claim 15, wherein the calculating of the suspension longitudinal deformation degree based on the corresponding pitch and the corresponding longitudinal force at the corresponding stop timing includes:
using a condition, in which a restoring force due to displacement of a suspension of the vehicle is in equilibrium with a longitudinal force

18. The method of claim 15, wherein the calculating of the suspension longitudinal deformation degree based on the corresponding pitch and the corresponding longitudinal force at the corresponding stop timing further includes:
calculating the corresponding pitch and the corresponding longitudinal force based on a braking torque of a brake in the driving state.

19. The method of claim 12, wherein the calculating and updating of the pitch rate step further includes:
using a pitch motion equation in the stop state.

20. The method of claim 11, wherein the calculating and updating of the control level step further includes:
calculating the control level such that the control level is proportional to the pitch rate.
